(19) United States
(12) Patent Application Publication
(10) Pub. No.: US 2004/0251679 A1
(43) Pub. Date: Dec. 16, 2004

(54) Cards and kits for use in alerting others that animals are in need of care

(76) Inventor: Kim B. Brignull, Valatie, NY (US)

Correspondence Address: HESLIN ROTHENBERG FARLEY & MESITI PC, 5 COLUMBIA CIRCLE, ALBANY, NY, 12203, US

(21) Appl. No.: 10/706,224

(22) Filed: Nov. 12, 2003

Related U.S. Application Data
(60) Provisional application No. 60/462,195, filed on Apr. 14, 2003.

(51) Int. Cl. G09C 3/00; B42D 15/00

(52) U.S. Cl. 283/74

(57) ABSTRACT

The card includes, in one embodiment, a substrate, emergency warning indicia disposed on the substrate, and indicia disposed on the substrate for requesting information and designating a printing area for identifying at least one of a) an address for locating the animal in need of care, and b) a contact person. In another embodiment, the card comprises first plastic wallet-sized substrate having emergency warning indicia and a second foldable paper substation having indicia disposed on the substrate for requesting information and designating a printing area for identifying an owner of the animal, an address of the owner, a contact person, veterinarian information, and a description of the animal. Kits include the card along with a sticker having emergency warning indicia corresponding to the card. The sticker is attachable to a building for locating the animal.

### RELATED APPLICATIONS

This application claims the benefit of U.S. Provisional Application No. 60/462,195, filed Apr. 14, 2003, entitled “Folding Wallet Size Cards Identifying Animals That Need To Be Cared For In Case Of An Emergency”, which is hereby incorporated herein by reference in its entirety.

### COPYRIGHT AUTHORIZATION

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

This invention relates generally to the care of animals, and more specifically, to cards and kits for alerting others that animals are in need of care, for example, in the event of an emergency.

### BACKGROUND OF THE INVENTION

Often when there is a fire in a home, firefighters and rescue workers are typically not aware whether there are any animals present in the home. One attempt at locating animals in the event of a fire in a home, is with the use of pet rescue or emergency window stickers. The pet rescue window stickers may be displayed on a home's exterior window, front door panel, or some other highly visible location to alert firefighters or other rescue personnel to the presence of pets in the home. These stickers include such information as how many dogs or cats are in the home.

In addition, every year thousands of animals are left abandoned in their own homes due to an unforeseen accident involving their owners. One attempt by the inventor of the present invention involved collecting from a pet owner, the owner's name, address, names of pets, contact persons, and veterinarian information, and permanently printing the information on a plastic card having an emergency warning symbol. The pet owner may carry the card in one's wallet or purse.

There is a further need for cards and kits for alerting others that animals are in need of care in the event of an emergency.

### SUMMARY OF THE INVENTION

In a first aspect, the present invention provides a card for use in alerting others that an animal is in need of care. The card includes a substrate, emergency warning indicia disposed on the substrate, and indicia disposed on the substrate for requesting information and designating a printing area for identifying at least one of a) an address for locating the animal in need of care, and b) a contact person.

In a second aspect, the present invention provides a card for use in alerting others that an animal is in need of care. The card includes a wallet-sized substrate, emergency warning indicia disposed on the substrate having a medical warning symbol and at least one image of an animal, and indicia disposed on the substrate for requesting information and designating a printing area for identifying an owner of the animal, an address of the owner, a contact person, veterinarian information, and a description of the animal.

In a third aspect, the present invention provides a card for use in alerting others that an animal is in need of care. The card includes a first substrate and a second substrate. The first substrate includes a first side and a second side, and an emergency warning indicia disposed on the first side. A second substrate includes a first side, a second side, and a score line defining the second substrate into foldable and overlapping first and second portions. The first portion is attached to the second side of the first substrate. Indicia is disposed on the second substrate for requesting information and designating a printing area identifying at least one of a) an address for locating the animal in need of care, and b) a contact person.

In a fourth aspect, the present invention provides a card for use in alerting others that an animal is in need of care. The card includes a first wallet-sized substrate and a second substrate. The first substrate includes a first side, a second side, and an emergency warning indicia disposed on the first side of the first substrate. The emergency warning indicia includes a medical warning symbol and at least one image of an animal. The second substrate includes a first side, a second side, and a score line defining the second substrate into foldable and overlapping wallet-sized first and second portions. Indicia is disposed on the second substrate for requesting information and designating a printing area for identifying an owner of the animal, an address of the owner, a contact person, veterinarian information, and a description of the animal.

In additional aspects, the present invention provides kits for use in alerting others that an animal is in need of care. The kits include the above-noted cards in combination with a sticker attachable to a building corresponding to the location of the animal. The sticker includes an emergency warning indicia, and the emergency warning indicia of the card corresponds to the emergency warning indicia of the sticker.

### BRIEF DESCRIPTION OF THE DRAWINGS

The subject matter which is regarded as the invention is particularly pointed out and distinctly claimed in the concluding portion of the specification. The invention, however, may best be understood by reference to the following detailed description of various embodiments and the accompanying drawings in which:

FIG. 1 is a perspective view of one embodiment of an animals home alone card in accordance with the present invention;

FIG. 2 is a front elevational view of one embodiment of a sticker in accordance with the present invention usable with the animals home alone card of FIG. 1;

FIG. 3 is a front elevational view of a first substrate of the animals home alone card of FIG. 1;

FIG. 4 is a rear elevational view of the first substrate of the animals home alone card of FIG. 1;

FIG. 5 is a sectional view of the animals home alone card taken along line 5-5 of FIG. 1;

FIG. 6 is a plan view of a first side of a second substrate of the animals home alone card of FIG. 1;

FIG. 7 is a plan view of a second side of the second substrate of the animals home alone card of FIG. 1;

FIG. 8 is a front elevational view of another embodiment of a sticker in accordance with the present invention for use with the animals home along card of FIG. 1;

FIG. 9 is a front elevational view of another embodiment of an animals home alone card in accordance with the present invention; and

FIG. 10 is a rear elevational view of the animals home alone card of FIG. 9.

### DETAILED DESCRIPTION OF THE INVENTION

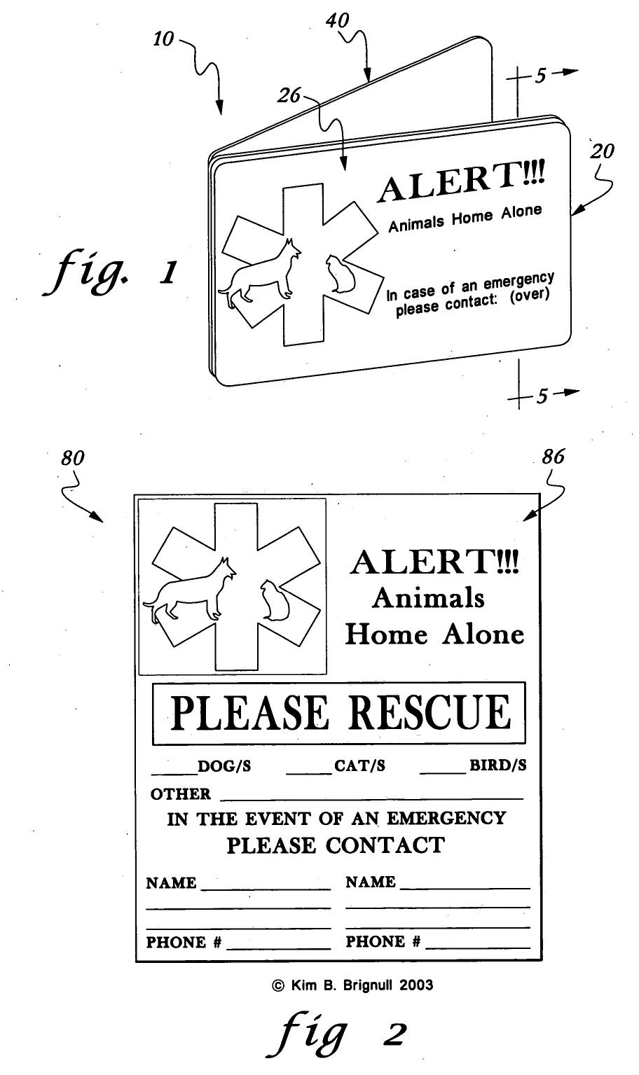

FIG. 1 illustrates one embodiment of an animals home alone card 10 in accordance with the present invention for use in alerting others that an animal is in need of care. As will become apparent from the description below, the animals home alone card may be carried by a pet owner, and in the case of an emergency, others may be alerted to the fact that the owner's pets are in need of care. The card provides pet owners with the security of knowing that their pets will not be forgotten in the event of an emergency or accident and where the pet owner is unable to return home.

The animals home alone card may be readily and inexpensively manufactured for widespread sale and purchase by pet owners, and particularly pet owners who live alone. The animals home alone card can then be completed by the pet owner by writing in the relevant information on the card, and carried in their wallet or purse such as next to a driver's license. For example, when an owner is unable to attend to their pets such as being involved in an automobile or other accident, policemen or medical personnel in identifying the owner may readily locate the animals home alone card and take the necessary steps to alert others of the need to attend to the owner's pets that are in need of care.

FIG. 2 illustrates a sticker 80 in accordance with the present invention which is attachable to a building, such as to a door or window of a home such as the pet owner residence where the pet is to be found. The animals home alone card and the sticker may be sold as a kit and include an emergency warning indicia 26 (FIG. 1) on the card which corresponds generally to the emergency warning indicia 86 on the sticker to aid alerting others of animals in the need of care and also confirm the location of the animals. The emergency warning stickers also let policemen, firefighters and helpful neighbors know that there are pets inside that need to be rescued in case of emergency such as a fire.

The stickers may also include the words “PLEASE RESCUE” and include space for writing in the number of dogs, cats, birds, and other animals. In addition, the sticker may include space for writing in one or more contact persons with the name, address, and telephone number thereof. The sticker may be a durable static cling sticker with thermal resin printing that can go on the inside facing out of a window or glass door.

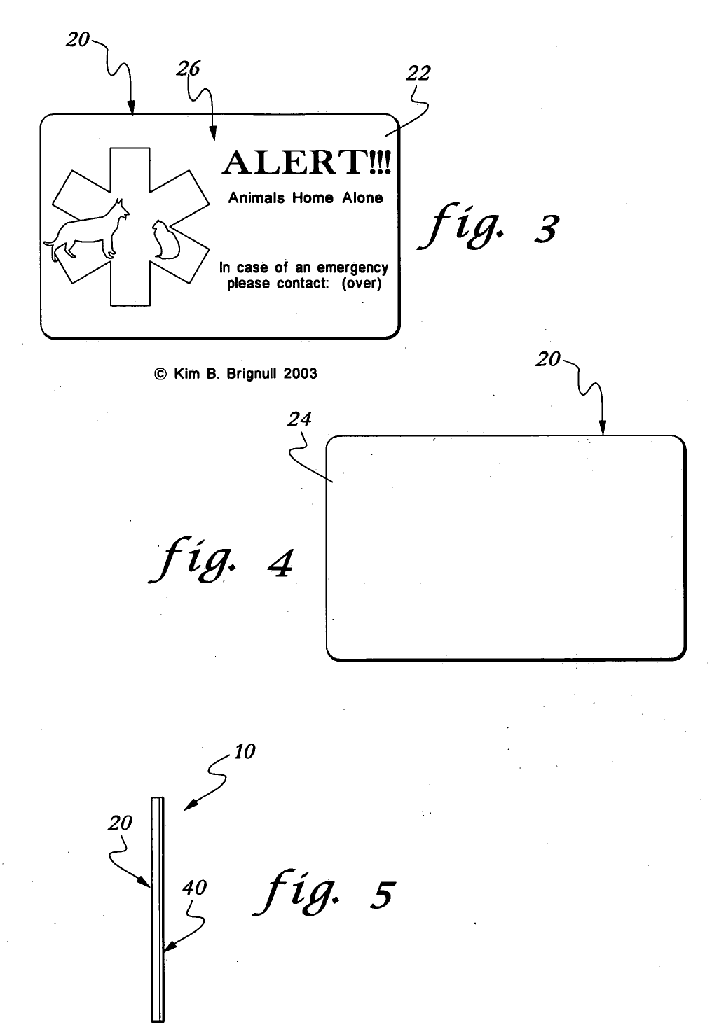

With reference again to FIG. 1, animals home alone card 10 may be in the form of a foldable card having a first substrate 20 and a second substrate 40. As shown in FIGS. 3-5, first substrate 20 includes a first side 22 (FIG. 3) and a second opposite side 24 (FIG. 4). Emergency warning indicia 26 may be disposed on the first side 22 alerting others that animals are in need of care. For example, the emergency warning indicia may be a typical first aid cross or symbol, medical warning symbol such as shown in FIG. 3, the words “ALERT”, “WARNING”, other symbols or words, and combinations thereof. The emergency warning indicia may comprise the color red e.g., a red cross or medical warning symbol to alert others that the card contains important emergency information. The emergency warning indicia may also include at least one animal such as a silhouette of a dog or cat. The second side 24 may be blank and attached to second substrate 40 as further described below. Substrate 20 may be formed from a plastic material such as a moisture resistant PVC (polyvinyl chloride) material and in the size of a wallet-sided card such as in the form of a credit card format having typically a 30-mil card thickness.

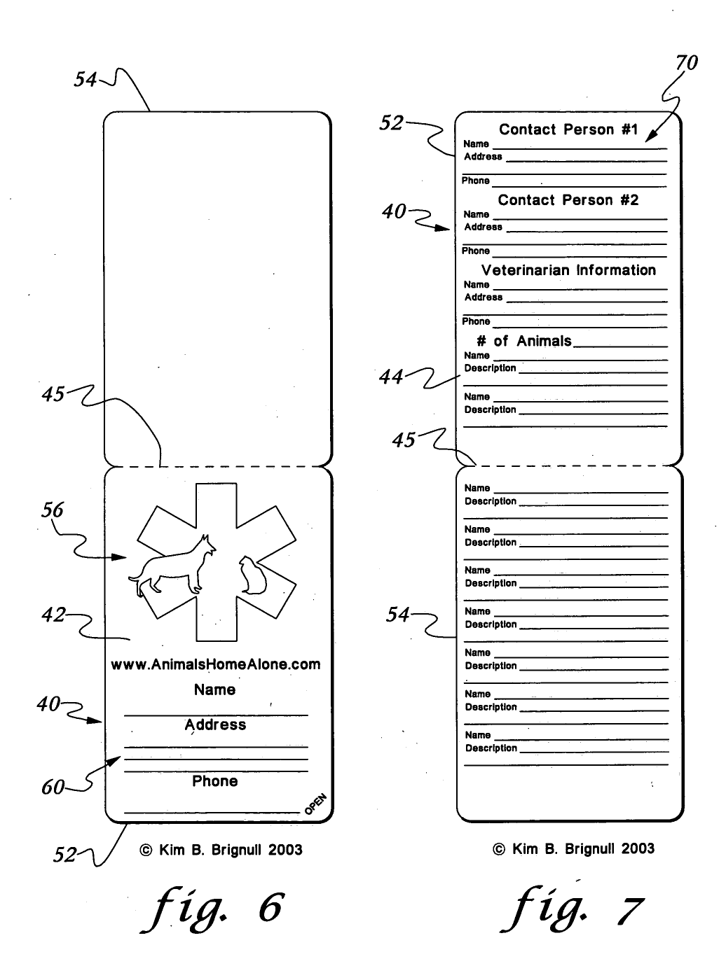

As shown in FIGS. 6 and 7, second substrate 40 may include a first side 42, a second side 44, and a score line 45 defining the second substrate into a first portion 52 and a second portion 54. The second substrate may be sized so that the score line divides the second substrate in half with each half corresponding in size to the size of the first substrate.

First portion 52 may include an emergency warning indicia 56 which may corresponds to the emergency warning indicia described above in connection with the first substrate and the sticker. Further indicia 60 may disposed on first portion 52 for requesting information and designating a printing area for identifying the pet owner's “Name”, the pet owner's “Address”, and the owner's “Telephone number.”

Additional indicia 70 may be disposed on second side 44 of second substrate 40 for requesting information and designating printing areas for identifying a “Contact Person or Persons” including the “Name”, “Address”, and “Telephone” number, “Veterinarian Information” including “Name”, “Address”, and “Telephone” number, “Number of Animals”, and a plurality of entries for entering the “Names” of the animals, and a “Description” of the animals.

The second substrate may be formed from paper or cardboard material having the indicia printed thereon. The substrate allows an owner to readily enter the requested information using a pen or pencil. In addition, the requested information may be changed when there is a change in the information, for example, when adding another pet, or changing a contact person.

Second portion 54, and in particular the first side of second portion 54, is attachable to second side 24 of first substrate 20, as shown in FIG. 5, using, e.g., a layer of adhesive. The two substrates attached together form an overlapping foldable card. FIG. 7 illustrates the animals home alone card when opened. The foldable card configuration allows the pet owner to enter more information and provides increase sized areas for the information compared to a card having only a front side and a rear side.

The kit for alerting others that animals are in need of care may be sold with one animal home alone card and a one sticker. In addition, the kit may include a plurality of animal home alone cards and a plurality of stickers.

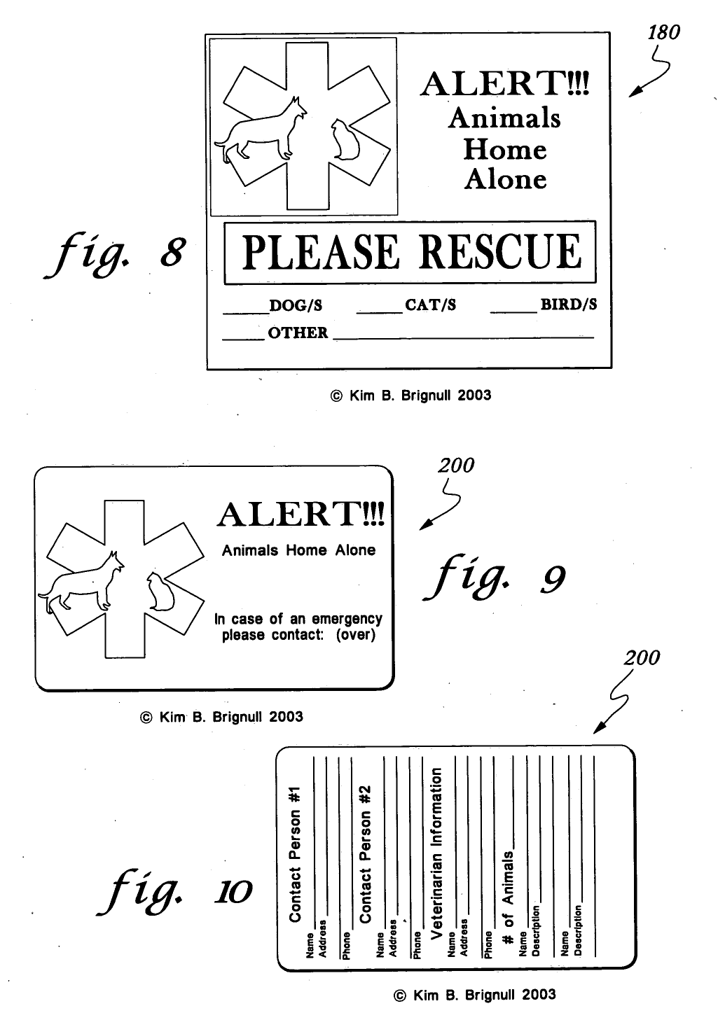

FIG. 8 illustrates another embodiment of a sticker 180 in accordance with the present invention.

FIGS. 9 and 10 illustrates another embodiment of an animal home alone card 200 which may include just a single substrate, e.g., a plastic credit card sized substrate with writable surfaces on the back for entering the relevant information for alerting others of pets that are in need of care.

Still other embodiments of the animals home alone card may include the second substrate comprising a foldable plastic material which allows printed information to be entered using a pen or pencil. The first substrate may be a generally rigid material which protects the second substrate.

While various embodiments of the present invention have been illustrated and described, it will be appreciated to those skilled in the art that many changes and modifications may be made thereunto without departing from the spirit and scope of the invention.

1. A card for use in alerting others that an animal is in need of care, said card comprising:
a substrate;
emergency warning indicia disposed on said substrate; and
indicia disposed on said substrate for requesting information and designating a printing area for identifying at least one of a) an address for locating the animal in need of care, and b) a contact person.

2. The card of claim 1 wherein said indicia comprises indicia for identifying said address for locating the animal in need of care.

3. The card of claim 1 wherein said indicia comprises indicia for identifying said contact person.

4. The card of claim 1 wherein said indicia comprises indicia for identifying said address for locating the animal in need of care and said contact person.

5. The card of claim 1 further comprising indicia disposed on said substrate for requesting information and designating a printing area for identifying a description of the animal.

6. The card of claim 1 further comprising indicia disposed on said substrate for requesting information and designating a printing area for identifying veterinarian information.

7. The card of claim 1 further comprising indicia disposed on said substrate for requesting information and designating a printing area for identifying an owner of the animal, veterinarian information, and a description of the animal.

8. The card of claim 1 wherein said emergency warning indicia comprises a cross.

9. The card of claim 1 wherein said emergency warning indicia comprises a medical warning symbol.

10. The card of claim 1 wherein said emergency warning indicia comprises a cross and images of at least one animal.

11. The card of claim 1 wherein said emergency warning indicia comprises the color red.

12. The card of claim 1 wherein said substrate comprises a wallet-sized card.

13. A kit for use in alerting others that an animal is in need of care, said kit comprising:
a card of claim 1;
a sticker attachable to a building corresponding to the location of the animal, said sticker comprising at least one emergency warning indicia; and
wherein said emergency warning indicia of said card corresponds to said emergency warning indicia of said sticker.

14. The kit of claim 13 wherein said sticker comprises indicia for requesting information and designating a printing area for identifying the number of and type of animal.

15. The kit of claim 13 wherein said sticker comprises indicia for requesting information and designating a printing area for identifying a contact person.

16. A card for use in alerting others that an animal is in need of care, said card comprising:
a wallet-sized substrate;
emergency warning indicia disposed on said substrate, said emergency warning indicia comprising a red medical warning symbol and at least one image of an animal; and
indicia disposed on said substrate for requesting information and designating a printing area for identifying an owner of the animal, an address of the owner, a contact person, veterinarian information, and a description of the animal.

17. A kit for use in alerting others that an animal is in need of care, said kit comprising:
a card of claim 16; and
a sticker attachable to a building corresponding to the location of the animal, said sticker comprising at least one emergency warning indicia; and
wherein said emergency warning indicia of said card corresponds to said emergency warning indicia of said sticker.

18. The kit of claim 17 wherein said sticker comprises indicia for requesting information and designating a printing area for identifying the number of and type of animal.

19. The kit of claim 17 wherein said sticker comprises indicia for requesting information and designating a printing area for identifying a contact person.

20. A card for use in alerting others that an animal is in need of care, the card comprising:
a first substrate comprising a first side and a second side;
an emergency warning indicia disposed on said first side;
a second substrate comprising a first side, a second side, and a score line defining said second substrate into foldable and overlapping first and second portions, said first portion being attached to said second side of said first substrate; and
indicia disposed on said second substrate for requesting information and designating a printing area for identifying at least one of a) an address for locating the animal in need of care, and b) a contact person.

21. The card of claim 20 wherein said indicia comprises indicia for identifying said address for locating the animal in need of care.

22. The card of claim 20 wherein said indicia comprises indicia for identifying said contact person.

23. The card of claim 20 wherein said indicia comprises indicia for identifying said address for locating the animal in need of care and said contact person.

24. The card of claim 20 further comprising indicia disposed on said second substrate for requesting information and designating a printing area for identifying a description of the animal.

25. The card of claim 20 further comprising indicia disposed on said substrate for requesting information and designating a printing area for identifying veterinarian information.

26. The card of claim 20 further comprising indicia disposed on said substrate for requesting information and designating a printing area for identifying an owner of the animal, veterinarian information, and a description of the animal.

27. The card of claim 20 wherein said emergency warning indicia comprises a cross.

28. The card of claim 20 wherein said emergency warning indicia comprises a medical warning symbol.

29. The card of claim 20 wherein said emergency warning indicia comprises a cross and images of at least one animal.

30. The card of claim 20 wherein said emergency warning indicia comprises the color red.

31. The card of claim 20 wherein said substrate comprises a wallet-sized card.

32. A kit for use in alerting others that an animal is in need of care, said kit comprising:
a card of claim 20; and
a sticker attachable to a building corresponding to the location of the animal, said sticker comprising at least one emergency warning indicia; and
wherein said emergency warning indicia of said card corresponds to said emergency warning indicia of said sticker.

33. The kit of claim 32 wherein said sticker comprises indicia for requesting information and designating a printing area for identifying the number of and type of animal.

34. The kit of claim 32 wherein said sticker comprises indicia for requesting information and designating a printing area for identifying a contact person.

35. A card for use in alerting others that an animal is in need of care, said card comprising:
a first wallet-sized substrate comprising a first side and a second side;
an emergency warning indicia disposed on said first side of said first substrate, said emergency warning indicia comprising a medical warning symbol and at least one image of an animal;
a second substrate comprising a first side, a second side, and a score line defining said second substrate into foldable and overlapping wallet-sized first and second portions; and
indicia disposed on said second substrate for requesting information and designating a printing area for identifying an owner of the animal, an address of the owner, a contact person, veterinarian information, and a description of the animal.

36. A kit for use in alerting others that an animal is in need of care, said kit comprising:
a card of claim 35; and
a sticker attachable to a building corresponding to the location of the animal, said sticker comprising at least one emergency warning indicia; and
wherein said emergency warning indicia of said card corresponds to said emergency warning indicia of said sticker.

37. The kit of claim 36 wherein said sticker comprises indicia for requesting information and designating a printing area for identifying the number and type of animal.

38. The kit of claim 36 wherein said sticker comprises indicia for requesting information and designating a printing area for identifying a contact person.
